(19) United States
(12) Patent Application Publication
(10) Pub. No.: US 2024/0278143 A1
(43) Pub. Date: Aug. 22, 2024

(54) ROTARY EVAPORATOR AND CONTROL MODULE THEREFOR

(71) Applicant: Hans Heidolph GmbH, Kelheim (DE)

(72) Inventors: Robert LOESCHEL, Schwabach (DE); Immo WEBER, Erlangen (DE)

(73) Assignee: Hans Heidolph GmbH, Kelheim (DE)

(21) Appl. No.: 18/581,973

(22) Filed: Feb. 20, 2024

(30) Foreign Application Priority Data
Feb. 20, 2023 (EP) 23157584.6

(51) Int. Cl. B01D 1/28; B01D 1/12; B01D 1/30

(52) U.S. Cl. CPC B01D 1/2896; B01D 1/2881; B01D 1/12; B01D 1/30

(57) ABSTRACT

The invention relates to a rotary evaporator (1) which is designed for the automatic execution of decompression steps during an overall process, in particular during distillation. With the decompression steps (III) to (VI), a complete removal of residual portions of condensed distillate at the inlet connection (71) of the intermediate valve (7) and in the condenser (5) of the rotary evaporator (1) can be accomplished. The rotary evaporator (1) has an electronic control module (9) which is designed and programmed to automatically carry out the decompression steps and other process steps with the rotary evaporator (1).

### FIELD OF TECHNOLOGY

The invention relates to a rotary evaporator for evaporating and condensing liquids or liquid mixtures under pressure reduction.

In particular, the invention relates to a rotary evaporator which has a control module designed to electronically control a system pressure generator and an intermediate valve, as well as the control module itself. The control module is designed to automatically perform consecutive control steps to set the system pressure and to open and close the intermediate valve.

The invention also relates to a distillation process which can be carried out with the proposed rotary evaporator.

### State of the Art and Definitions

The separation of homogeneous or heterogeneous liquid mixtures into fractions by means of distillation under pressure reduction, which also includes the evaporation of solid solutions, the drying of solids or solid mixtures and the decomposition of substances into volatile components, is one of the basic operations in chemical process engineering and in laboratory practice.

Electronically controllable rotary evaporators have a system pressure generator, an evaporation flask, a condenser, at least one receiving flask, an electronic control module and optionally an intermediate valve. The electronically controllable system pressure generator has an electronically controllable vacuum pump, electronically controllable valves and an electronically readable pressure gauge (manometer) as an assembly. The control module is designed for electronically controlling the system pressure generator and optionally for electronically controlling an intermediate valve and/or for controlling a temperature control bath and/or the rotational speed of the evaporation flask. Rotary evaporators are described, for example, in the textbook: Walter Wittenberger, Chemische Laboratoriumstechnik, 7th edition, Springer-Verlag Wien/New York 1973, page 186-187 and in the textbook: Klaus Schwetlik (author), Heinz G. O. Becker, Werner Berger, Günter Domschke, Organikum: organisch-chemisches Grundpraktikum, 23rd edition, Wiley-VCH Weinheim 2009.

The system pressure (hereinafter referred to or abbreviated as: pS) of a distillation device and thus of a rotary evaporator corresponds to the average internal gas pressure which is given in the interior of the distillation device during its operation, for example during the performance of a distillation, at a point in time or at a time (hereinafter referred to or abbreviated as: t).

In the following, an overall process is generally understood to mean a distillation under pressure reduction within a total time interval (hereinafter referred to or abbreviated as: ΔT_{ges}), wherein the distillation comprises n steps i, n corresponds to a natural number and i as a natural number corresponds to an index number between 1 and n (i={1, . . . n}). Each step i comprises m time intervals (hereinafter referred to or abbreviated as: Δtⱼᵢ, where m again corresponds to a natural number and j as a natural number corresponds to an index number between 1 and m (j={1, . . . m}).

The overall process of a distillation thus comprises the reduction of the system pressure pS from an initial pressure (hereinafter referred to or abbreviated as: p_{A}) in the first time interval Δt₁₁ of the first step (j=1; i=1) to a final pressure (hereinafter referred to or abbreviated as: p_{E} or abbreviated) in the last time interval Δtₘₙ of the last step (j=m; i=n), that is, in total in one or more time intervals Δtⱼᵢ within the overall time interval ΔT_{ges}, the last time interval Δtₘₙ being referred to below as the final time interval (also abbreviated as: Δt_{E}). In such an overall process, the initial pressure p_{A} corresponds at most to the prevailing atmospheric pressure, i.e. approximately 1000 mbar. In the interior of a rotary evaporator, a reduced pressure of up to 2×10⁻³ mbar can be realized as the final pressure p_{E} by means of the system pressure generator. A time interval Δtⱼᵢ comprises an adjustment of the system pressure p_{S} to a set pressure value or maintaining the system pressure p_{S} at a set pressure value, whereby the sum of all time intervals Δtⱼᵢ corresponds to the total time interval ΔT_{ges}.

An overall process is therefore at least one-step (n=1; i=1) and has at least one time segment Δt₁₁ (m=1; j=1), whereby in this case the time segment Δt₁₁ corresponds to the final time segment Δt_{E}.

Electronically controllable rotary evaporators are known whose control module is designed to automatically perform control steps in time intervals Δtⱼᵢ. In this case, the sequence of execution of these control steps is defined on the control module by programming with regard to adapting the system pressure p_{S} to a pressure setpoint value to be set or maintaining the system pressure p_{S} at a pressure setpoint value to be set. The following parameters can therefore be set on the control module for the automatic execution of an overall process:
the initial pressure p_{A} and the final pressure p_{E},
the individual time intervals Δtⱼᵢ and the end time interval Δt_{E} each as time lengths or, if not defined on the control module by programming, as switching times,
constant pressure setpoints p_{Sji} for individual time periods Δtⱼᵢ,
unless specified on the control module by programming, individual time intervals Δtⱼᵢ with regard to an adaptation of the constant pressure p_{S(m-1)i} or p_{Sm(i-1)} set for an upstream time interval, i.e.: Δₜ₍ₘ₋₁₎ᵢ or Δtₘ₍ᵢ₋₁₎, to a constant pressure p_{Smi} or p_{S1i} set for a downstream time interval, i.e.: Δtₘᵢ or Δt₁ᵢ,
if not defined on the control module by programming, final time interval Δt_{E} with regard to the adaptation of the constant pressure p_{S(m-1)n} set for the penultimate time interval Δt₍ₘ₋₁₎ₙ to the final pressure p_{E}.

A switching time is therefore understood to be such a time interval Δtⱼᵢ in which a setpoint value of the system pressure p_{S} can be reached from a current or preset value of the system pressure p_{S} in the direct and technically fastest possible way, i.e. in the technically shortest possible time. In a rotary evaporator, the switching time required for a pressure reduction therefore depends on the general unit capacity of the vacuum pump of the system pressure generator and for a pressure increase on the capacity of the vent valve of the system pressure generator. Within the pressure interval of 1000 mbar to 2×10⁻³, there is no constant pressure changeover speed, i.e. the quotient of the pressure difference to be overcome and the time required for this is not constant within this pressure interval. Typical orientation values for switching times are as follows: A pressure reduction from 1000 mbar to 5 mbar can be accomplished in about 1 min 40 s to 2 min, a pressure reduction from 5 mbar to 2×10⁻³ mbar can be accomplished in about 5 min to 10 min, a pressure change of 100 mbar above 5 mbar can be accomplished in about 1 s to 3 s and a pressure change of 10 mbar above 5 mbar can be accomplished in about 10⁻³ s to 1 s.

A process pressure (hereinafter referred to or abbreviated as: p_{Pi}) of a step i is generally understood to be the constant system pressure p_{Smi} set for a time interval Δtₘᵢ, at which a desired operation, in particular with regard to the vaporization of a liquid or liquid mixture from the vaporization flask, can be carried out. For example, for the distillative separation of a liquid mixture, the process pressure p_{Pi} is set to the boiling pressure (hereinafter referred to or abbreviated as: p_{S1i}) of a fraction. For example, in the final phase of drying a solid, the process pressure p_{Pi} is set well below the boiling pressure p_{S1i} of the liquid solvent with which the solid is mixed. To completely remove a more volatile component from a liquid two-component mixture, the process pressure p_{Pi} is also set well below the boiling pressure p_{S1i} of the volatile component.

Each fraction of a distillation has at least one component, for example in the form of a pure substance or a molecular associate, or a mixture of several components. If several components of a liquid mixture to be distilled, which is contained in the evaporation vessel, have the same or similar boiling pressures, these boiling pressures can be measured as a single averaged boiling pressure p_{S1i} due to the system. This is particularly the case when an azeotrope is present. If the boiling pressure p_{S1i} of a fraction is referred to below, this includes an averaged boiling pressure of a mixture of several components.

Electronically controllable rotary evaporators have an electronic control module which is designed to automatically carry out the following process steps (I) and (II) once or several times in the specified sequence within a step i of n consecutive steps in each case:
(I) reducing the current system pressure p_{S} from the initial pressure p_{A} or from the step process pressure p_{P(i-1)} of the step (i−1) upstream step i to a process pressure p_{Pi} within a first time interval Δt₁ᵢ,
(II) holding the process pressure p_{Pi} for a second time interval Δt₂ᵢ in step i and then process step (I) followed by the process step (II) for the respective step (i+1) downstream of step i and, after passing through the last step (i=n), reducing the last process pressure p_{Pn} to a final pressure p_{E} in a final time interval Δt_{E}.

In this case, the first time interval Δt₁ᵢ can be set on the control module or can be defined or fixed as a switching time. Fractional distillation can be carried out with such an electronically controllable rotary evaporator. Each process pressure p_{Pi} is set to the boiling pressure p_{S1i} of the fraction obtained in the relevant step i on the control module. Each process pressure pPi of step i is lower than the process pressure p_{P(i-1)} of the step (i−1) upstream step i. Consequently, n steps i, n process pressures p_{Pi} and thus n boiling pressures p_{S1i} are run through in the total time interval Δt_{ges}, where n corresponds to the number of separable fractions or fractions of a liquid mixture to be separated. The total time interval Δt_{ges} is thus composed of the first time interval Δt₁ᵢ and the second time interval Δt₁ᵢ of each step i.

In the following, a display is understood to be a component which generally comprises a device for visualizing or optically signaling variable information, such as states and values, in particular measured values. An electronic display is, for example, a screen on which the variable information can be visualized. In the following, a touch screen is understood to be a touch-sensitive surface with which data can be entered quickly and precisely into a technical device. Electronic control modules of rotary evaporators usually have an optional electronic display, which is designed for setting via an electronic touchscreen, for displaying and for graphically representing control steps. In this case, the touchscreen is part of the display.

In rotary evaporators in which a receiving flask is directly connected to the condenser, boiling back and/or flashback of the distillate from the receiving flask into the condenser is almost unavoidable if a process pressure p_{Pi} below the boiling pressure p_{S1i} of the distillate is selected. This can be avoided by an intermediate valve between the condenser and the receiving flask if this is closed at a process pressure p_{Pi} below the boiling pressure p_{S1i} of the distillate.

Such an intermediate valve has an inlet connection to the condenser and an outlet connection to a receiving flask. The intermediate valve is designed for selective, i.e. switchable, separation of a collection flask from the condenser by closing and for connection of the collection flask to the condenser by opening. The intermediate valve is thus provided for draining a distillate or a fraction of a distillate into a receiving flask.

In the simplest case, this can be realized by an intermediate valve, which is designed as a mechanical non-return valve for automatic closure in the event of a low pressure in the condenser as well as in the evaporation flask and in the event of an overpressure in the relevant collection flask due to a boilback or flashback of the distillate. However, this solution is only suitable to a limited extent, as there is still a flashback of a residual portion of the distillate when the intermediate valve is closed. However, the function of such a non-return valve cannot be further influenced, i.e. controlled, but is only designed to automatically close the receiving flask in the event of a sudden overpressure in the receiving flask. Such a mechanical non-return valve therefore leads to considerable unfavorable and uncontrollable pressure fluctuations during the process.

However, an electronically controllable intermediate valve can be used to close or open the inlet connection independently of the prevailing pressure in the receiving flask and in the condenser. Before a process pressure p_{Pi} is reached, it is therefore possible to prevent the distillate from boiling back or reboiling out of the collection flask by closing the inlet connection before or when the distillate falls below the boiling point p_{S1i}. The intermediate valve is therefore preferably designed as an electronically switchable solenoid valve. Opening and closing can thus be freely selected or controlled via an overall process depending on the purpose.

The size of the intermediate valve and thus of the input connection is limited in order to achieve the shortest possible switching time, which is required for closing or opening the intermediate valve, and should therefore be as small as possible. However, during a process with the rotary evaporator, this often leads to an accumulation of distillate in the condenser and especially in front of and at the inlet connection, even when the intermediate valve is open, as the distillate cannot flow off quickly enough and thus not completely into the receiving flask due to the small size of the inlet connection. This effect can be observed in particular with distillates with a high viscosity and/or surface tension and/or with a high boiling point. In fractional distillation, this effect causes only partial separation, i.e. partial mixing of different fractions within the condenser during a distillation process. An accumulation of distillate in the condenser and at the inlet connection of the intermediate valve therefore often forces the distillation to be stopped by venting the rotary evaporator.

### Technical Problem

The invention is based on the problem of providing an improved rotary evaporator compared to the prior art, in which an accumulation of the distillate in the condenser and/or in the intermediate module can be avoided and/or solved without great effort.

### Solution to the Problem

The rotary evaporator according to the invention is designed for separating fractions of a liquid or liquid mixture by distillation. The rotary evaporator can be used to separate both homogeneous and heterogeneous liquid mixtures. This includes the separation of solvents from homogeneous solid solutions as well as the drying of solids or solid mixtures to isolate solids or solid mixtures.

The electronically controllable rotary evaporator according to the invention has an evaporation flask, optionally a temperature control bath, a condenser, a system pressure generator for generating a system pressure p_{S}, an intermediate valve, at least one receiving flask and a control module. The condenser is connected both to the system pressure generator and to the intermediate valve. The intermediate valve is connected directly or indirectly to each receiving flask.

The evaporation flask is connected to a steam pipe, whereby the steam pipe is guided into the condenser by a shaft seal. Alternatively, the evaporation flask is connected directly to the shaft seal via a flange connection. The evaporation flask can be set in rotation by means of an electric motor.

The evaporation flask is designed to hold a liquid, in particular a liquid mixture to be separated. The evaporation flask is designed, for example, as a glass flask or generally as a suitable evaporation container.

The temperature control bath of the rotary evaporator according to the invention is designed as a heating or cooling device that can be electronically controlled with respect to temperature, in which the evaporation flask is placed during operation of the rotary evaporator and can be heated or cooled with respect to its contents via a temperature control medium, in particular water or oil. As an alternative to a liquid as a temperature control medium, a heat-transferring powder or granular solid, a heat-transferring thermoplastic or air flow can be used.

The condenser is designed to discharge a liquid distillate via the intermediate valve into the collecting container(s) and, for example, as a spiral condenser with a cooling spiral running through its interior. The condenser can be cooled by means of a cooling liquid that is tempered to a constant temperature and continuously passed through the cooling spiral. This can be achieved using a circulation condenser, for example. The condenser and the cooling coil form a single part and are manufactured, for example, as a composite component made of glass or another suitable material. During distillation, the temperature of the cooling coil of the condenser is always kept lower than that of the temperature control medium.

Each collection flask is designed to hold a distillate, in particular fractions of a liquid or liquid mixture separated by distillation. A collection flask is designed, for example, as a glass flask or generally as a suitable collection container.

The electronically controllable system pressure generator has an electronically controllable vacuum pump, an electronically controllable control valve, optionally an electronically controllable vent valve and an electronically readable pressure gauge, whereby the system pressure can be measured with the pressure gauge. The vacuum pump is designed, for example, in the form of an electric diaphragm pump or a rotary vane pump. The electronically readable pressure gauge is designed, for example, as an electronic Pirani probe. The control valve is designed, for example, as an electronically controllable solenoid valve.

The electronically controllable intermediate valve is designed for selective, i.e. switchable, separation of each receiving flask from the condenser and for draining a distillate into each receiving flask.

The control module is electronically connected to the vacuum pump, the control valve, the ventilation valve, the intermediate valve and optionally to the temperature control bath and/or the electric motor, optionally via electrical cables and/or via a wireless local area network (WLAN). The control module can be used to set the system pressure p_{S} via the electronically controllable vacuum pump, via the electronically controllable control valve and via the optional electronically controllable ventilation valve using the values of the electronically controllable system pressure generator read electronically from the pressure gauge. The control module is optionally designed to control the temperature control bath and/or the rotation speed of the evaporation flask. Optionally, the control module has an electronic display with an electronic touchscreen.

The above-mentioned task is solved by the electronic control module of the rotary evaporator according to the invention being designed and programmed to automatically carry out subsequent decompression steps (III) to (VII) in the specified sequence within a step i or as a separate step i of n consecutive steps of an overall process in each case:
(III) with the intermediate valve open, reducing a first system pressure (hereinafter referred to or abbreviated as: p_{S1i}) to a first limit pressure (hereinafter referred to or abbreviated as: p_{Gai}) within an upstream decompression time interval (hereinafter referred to or abbreviated as: Δt₃ᵢ),
(IV) with the intermediate valve open, increasing the current system pressure p_{S}, i.e. p_{S}=p_{Gai}, from the first limit pressure p_{Gai} to a holding pressure (hereinafter referred to or abbreviated as: p_{Hi}) in a subsequent decompression time interval (hereinafter referred to or abbreviated as: Δt₄ᵢ),
(V) with the intermediate valve open, maintaining the holding pressure p_{Hi} for a next decompression time interval (hereinafter referred to or abbreviated as: Δt₅ᵢ),
(VI) with the intermediate valve open, reducing the holding pressure p_{Hi} to a second limit pressure (hereinafter referred to or abbreviated as: p_{Gbi}) in a further decompression time interval (hereinafter referred to or abbreviated as: Δt₆ᵢ) and closing the intermediate valve when the second limit pressure p_{Gbi} is reached,
(VII) with the intermediate valve closed, regulating the second limit pressure p_{Gbi} to a second system pressure (hereinafter referred to or abbreviated as: p_{S2i}) within a final decompression time interval (hereinafter referred to or abbreviated as: Δt₇ᵢ).

The step number i corresponds to an index, i.e. a mathematical numbering element. The number of steps i is a natural number from 1 to n, where n also corresponds to a natural number from 1 to the number of steps i that can be carried out with the rotary evaporator with respect to identical, partially identical or different operations within an overall process. The proposed rotary evaporator can generally be used to perform up to ten identical, partially identical or different operations within an overall process. For example, a one-step overall process (n=1) comprises the distillative recovery of an oxy-Cope product from the thermal rearrangement of an allyl ether in the heated evaporation flask of the rotary evaporator, with residues of the product being obtainable from the condenser and at the inlet connection of the intermediate valve to increase the yield when steps (III) to (VII) are carried out. For example, in a three-step (n=3) distillative processing of a liquid solids slurry with the rotary evaporator, in a first step (i=1) and in a second step (i=2) in each case a fraction of one of two solvents is obtainable in the relevant collection flask and in the last step (i=3) a dry solid is obtainable in the evaporation flask while maintaining a sufficiently low system pressure p_{S}, wherein after the first and second steps, residues of the respective distillate are removed from the condenser and at the inlet connection of the intermediate valve by carrying out the decompression steps (III) to (VII). Thus, the decompression steps (III) to (VII) are part of an overall distillation process over an overall time interval ΔT_{ges}. In general, in an overall process, the decompression steps (III) to (VII) are preceded by no control step or one or more control steps and/or followed by no control step or one or more control steps; this includes the sequential repetition of the decompression steps (III) to (VII) in one and the same overall process.

The control module can be used to set the first system pressure p_{S1i}, the second system pressure p_{S2i}, the first limit pressure p_{Gai}, the holding pressure p_{Hi}, the second limit pressure p_{Gbi} and the time interval Δt₅ᵢ or the first limit pressure p_{Gai}, the holding pressure p_{Hi} and the second limit pressure p_{Gbi} can be set automatically in relation to the first system pressure pS1i, whereby the time intervals Δt₃ᵢ, Δt₄ᵢ, and Δt₆ᵢ are each set as switching times on the control module by programming. The time interval Δt₇ᵢ can be set with the control module or defined as a switching time. Furthermore, the first system pressure p_{S1i} is less than, equal to or greater than the second system pressure p_{S2i}.

Alternatively, for a second system pressure p_{S2i} equal to or less than the second limit pressure p_{Gbi} the time intervals Δt₆ᵢ and Δt₇ᵢ are defined on the control module as a combined decompression time interval corresponding to a switching time (hereinafter referred to as: (Δt₆+Δt₇)ᵢ or abbreviated) in the form of a combined final decompression step (hereinafter referred to as: [(VI)+(VII)] or abbreviated). The automatic execution of the combined final decompression end step [(VI)+(VII)] comprises the reduction of the holding pressure p_{Hi} to the second system pressure p_{S2i} while closing the intermediate valve when the second limit pressure pGbi is passed.

For each step i, which comprises the decompression steps (III) to (VI) or (III) to [(VI)+(VII)], the first limit pressure p_{Gai}, the holding pressure p_{Hi} and the second limit pressure p_{Gbi} can be set on the control module as follows or can be set automatically in relation to the first system pressure p_{S1i}:
the first limit pressure p_{Gai} can be set to a lower pressure value than the first system pressure p_{S1i} or can be automatically set to a lower pressure value than the first system pressure p_{S1i} by entering a first reduction amount (hereinafter referred to or abbreviated as: δ_{Gai}) or can be automatically set as a product of the first system pressure p_{S1i} with the factor fGai by entering a first proportion factor (hereinafter referred to or abbreviated as: f_{Gai}),
the holding pressure p_{Hi} can be set to a higher pressure value than the first system pressure p_{S1i} or can be automatically set to a higher pressure value than the first system pressure p_{S1i} by entering an increase amount (hereinafter referred to or abbreviated as: δ_{Hi}) or can be automatically set as a product of the first system pressure p_{S1i} with the factor f_{Hi} by entering a holding pressure factor (hereinafter referred to or abbreviated as: f_{Hi}), and
the second limit pressure p_{Gbi} can be set to a lower pressure value than the holding pressure p_{Hi} or can be set automatically to a lower pressure value than the holding pressure p_{Hi} by entering a second reduction amount (hereinafter referred to or abbreviated as: δ_{Gbi}) or can be set automatically by entering a second proportion factor (hereinafter referred to or abbreviated as: f_{Gbi}) as a product of the first system pressure p_{S1i} with the factor f_{Gbi},
   wherein the first limit pressure p_{Gai} is less than or equal to the second limit pressure p_{Gbi}, wherein the first limit pressure p_{Gai} as well as the second limit pressure p_{Gbi} is not less than the maximum lowest pressure that can be generated with the system pressure generator and wherein the holding pressure p_{Hi} is not higher than the pressure given at the beginning of an overall process and thus not higher than the atmospheric pressure.

To carry out the decompression steps (III) to (VII) or the decompression steps (III) to [(VI)+(VII)], the factors f_{Gai} and f_{Gbi} can each be set to greater than 0 and less than 1 and the factor f_{Hi} can be set to greater than 1 on the control module. To perform the decompression steps, the proportional factors f_{Gai} and f_{Gbi} typically cover a range from less than 1 (corresponds to less than 100% of the first system pressure p_{S1i}) to 0.8 (corresponds to 80% of the first system pressure p_{S1i}). To carry out the decompression steps, the holding pressure factor f_{Hi} typically covers a range of more than 1 (corresponds to more than 100%) to 1.5 (corresponds to 150% of the first system pressure p_{S1i}).

If the decompression time interval Δt₅ᵢ is set to zero on the control module for one or more or all steps i and
the relevant first limit pressure p_{Gai} is set equal to the holding pressure p_{Hi} and equal to the second limit pressure p_{Gb} and equal to the first system pressure p_{S1i}, i.e.: p_{Gai}=p_{Hi}=p_{Gbi}=p_{S1i}, or
the first decrease amount δ_{Gai}, the increase amount δ_{Hi} and the second decrease amount δ_{Gbi} are set to zero, i.e.: δ_{Gai}=δ_{Hi}=δ_{Gbi}=0, or
the factors f_{Gai}, f_{Gbi} and f_{Hi} are set to 1, i.e.: f_{Gai}=f_{Gbi}=f_{Hi}=1,
   then for step i or the relevant steps i, the execution of the decompression steps (III) to (VI) or (III) to [(VI)+(VII)] is stopped. This makes it particularly advantageous to select the execution of the decompression steps (III) to (VII) or (III) to [(VI)+(VII)] for one step i or for several or for all steps i for an overall process on the control module as required. This is particularly indicated for fractions with a relatively small volume range and/or distillates of very low viscosity.

By reducing the first system pressure p_{S1i} to the first limit pressure p_{Gai} in the decompression step (III), a short-term negative pressure can be generated in the collection flask. In the decompression step (III), the generated negative pressure thus causes a short-term suction of a residual component of a distillate remaining in the condenser and, in particular, upstream of and at the inlet connection of the intermediate valve from the condenser. With the decompression step (III), in the time interval Δt₃ᵢ for the subsequent decompression steps (IV) and (V), it is thus possible to initiate a flow of this remaining residual component of a distillate through the open intermediate valve into the relevant collection flask. Evaporation loss of residual distillate remaining in the condenser is negligible due to the short switchover time of time interval Δt₃ᵢ.

For the decompression step (IV), a holding pressure p_{Hi} above the boiling pressure p_{S1i} of the residual component of a distillate remaining in the condenser and upstream of and at the inlet connection of the intermediate valve can be set with the control module or automatically adjusted with respect to the first system pressure p_{S1i}. An evaporation loss of this residual component through the condenser into the system pressure generator is thus particularly advantageously prevented. Any evaporation loss of residual components of a distillate remaining in the condenser below its boiling pressure p_{S1i} can also be neglected in the short switchover time given as time interval Δt₄ᵢ.

For the decompression step (V), a sufficiently long decompression time interval Δt₅ᵢ can be set with the control module, in which the most complete possible outflow of the residual distillate component remaining in the condenser through the open intermediate valve into the relevant collection container is ensured. Typically, the decompression time interval Δt₅ᵢ comprises 3 s to 10 min.

In the decompression step (VI), due to the short switchover time interval Δt₆ᵢ and by closing the intermediate valve when the second limit pressure p_{Gbi} is reached, the formation of excessive negative pressure and thus boiling of the distillate in the relevant collection flask is again prevented.

The decompression step (VII) comprises the regulation of the second limit pressure p_{Gbi} to a second system pressure p_{S2i} in a final decompression time interval Δt₇ᵢ. If the time interval Δt₇ᵢ is set on the control module, this typically comprises 10⁻³ s to 6 h.

If the second system pressure p_{S2i} is equal to the second limit pressure p_{Gbi}, then the control module is programmed to recognize the time interval Δt₃ᵢ and the time interval Δt₇ᵢ as a single final decompression time interval (hereinafter referred to as: (Δt₆ᵢ=Δt₇ᵢ), i.e. in this case, the time interval Δt₆ᵢ corresponds to a finite switchover time and the time interval Δt₇ᵢ corresponds to a formal switchover time of 0 s.

If the decompression steps (VI) and (VII) are defined or selected on the control module by programming as a combined final decompression step [(VI)+(VII)], the closing of the intermediate valve when the second limit pressure p_{Gbi} is reached and the regulation of the second limit pressure p_{Gbi} to a second system pressure p_{S2i} is accomplished in a single step.

This means that the proposed rotary evaporator can be used to achieve almost complete discharge of the residual distillate component remaining in the condenser and, in particular, upstream of and at the inlet connection of the intermediate valve through the open intermediate valve into the receiver flask when carrying out the decompression steps (III) to (VII) or (III) to [(VI)+(VII)] within an overall process. This makes it possible to achieve the shortest possible switching time, which is required for closing or opening the intermediate valve, with the smallest possible input connection of the intermediate valve. Furthermore, the proposed rotary evaporator prevents excessive negative pressure and thus boiling of the distillate in the relevant collection flask. Reboiling or flashback of the distillate from the relevant collection flask can therefore be completely avoided with the proposed rotary evaporator.

In the simplest case, the overall process thus has at least the decompression steps (III) to (VII) or (III) to [(VI)+(VII)] (n=1; i=1), the overall process being divided exclusively into the time intervals Δt₃ᵢ, Δt₄ᵢ, Δt₅ᵢ, Δt₆ᵢ and Δt₇ᵢ or into the time intervals Δt₃ᵢ, Δt₄ᵢ, Δt₅ᵢ und (Δt₆+Δt₇)ᵢ in the specified order.

In one embodiment of the present invention, the first limit pressure p_{Gai} of step i is equal to the second limit pressure p_{Gbi} of the same step i and thus corresponds to an equivalent limit pressure (hereinafter referred to or abbreviated as: p_{Gi}) of step i, that iS: p_{Gai}=p_{Gbi}=p_{Gi}. Here, on the control module, the equivalent limit pressure p_{Gi} for each step i, which has the decompression steps (III) to (VI) or (III) to [(VI)+(VII)]:
can be set to a lower pressure value than the first system pressure p_{S1i} or
can be automatically set to a lower pressure value than the first system pressure p_{S1i} with respect to the first system pressure p_{S1i} by entering an equivalent reduction amount (hereinafter referred to or abbreviated as: δ_{Gi}) or
can be automatically determined with respect to the first system pressure p_{S1i} by entering a proportion factor (hereinafter referred to or abbreviated as: f_{Gi}) of the same value as a product of the first system pressure p_{S1i} with the factor f_{Gi},
   wherein the factor f_{Gi} can be set greater than 0 and less than 1 on the control module in order to carry out the decompression steps (III) to (VII) or (III) to [(VI)+(VII)]. Typically, the equivalent proportional factor f_{Gi} for carrying out the decompression steps covers a range of less than 1 (corresponds to less than 100% of the first system pressure p_{S1i}) to 0.8 (corresponds to 80% of the first system pressure p_{S1i}).

If the decompression time interval Δt₅ᵢ is set to zero on the control module for one or more or all steps i and
the relevant equivalent limit pressure p_{Gi} is set equal to the holding pressure p_{Hi} and equal to the first system pressure p_{S1i}, i.e.: p_{Gi}=p_{Hi}=p_{S1i}, or
the equivalent decrease amount δ_{Gi} and the increase amount δ_{Hi} are set to zero, i.e.: δ_{Gi}=δ_{Hi}=0, or
the factors f^{Gi} and f_{Hi} are set to 1, i.e.: f_{Gi}=f_{Hi}=1, then, for step i or the relevant steps i, the execution of the decompression steps (III) to (VI) or (III) to [(VI)+(VII)] are then again turned off.

The equivalent limit pressure poi is therefore, if necessary, selected or automatically set such that a short-term negative pressure can be generated in the collection flask in decompression step (III), at which boiling of the distillate in the relevant collection flask in decompression steps (III), (IV) and (VI) does not occur or is negligible. Thus, the equivalent limit pressure p_{Gi} is greater than the boiling pressure p_{Bi} of the distillate in the respective receiving flask and less than the holding pressure p_{Hi}.

By equating the first limit pressure p_{Gai} with the second limit pressure p_{Gbi} to the equivalent limit pressure p_{Gi}, a parameter for the decompression step (III) or the decompression step (VI) or [(VI)+(VII)] that is to be specified or determined with the control module is thus advantageously omitted.

In a further embodiment, the control module is designed and programmed to automatically perform the decompression steps (III) to (VII) by manually triggering a command, which is hereinafter referred to as the decompression command, at any time t1 within an overall process. A first system pressure p_{S1i} is given at time t1.

The overall process is interrupted when the decompression command is executed. After the decompression command has been executed, the overall process is continued. The original time segment Δt_{ges} of the overall process is thus extended by the time segments Δt₃ᵢ, Δt₄ᵢ, Δt₅ᵢ, Δt₆ᵢ and Δt₇ᵢ. This requires the first system pressure p_{S1i} to be set equal to the second system pressure p_{S2i} on the control module.

A time interval Δt₅ᵢ can optionally be preset on the control module for the execution of the decompression command. Alternatively, a time interval Δt₅ᵢ can be selected by a switching duration of an actuated switching device, for example by holding down a switched button, after passing through the time intervals Δt₁ᵢ bis Δt₄ᵢ during execution of the decompression command. After the end of the switching time, for example by releasing the actuated button, the control module is designed for the subsequent automatic execution of the decompression steps (VI) and (VII), whereby the time intervals Δt₃ᵢ, Δt₄ᵢ, Δt₆ᵢ and Δt₇ᵢ are programmed on the control module in the form of automatically executable switching steps and are thus defined as switching times. To ensure that the decompression command can be carried out over the entire range of the system pressure that can be generated by the system pressure generator, the control module is programmed with the following parameters:
the holding pressure p_{Hi} by entering a holding pressure factor f_{Hi},
the first limit pressure p_{Gai} by entering a first proportional factor f_{Gai} and the second limit pressure p_{Gbi} by entering a second proportional factor f_{Gbi} or the equivalent limit pressure p_{Gi} by entering an equivalent proportional factor f_{Gi}
   can each be defined as a product of the first system pressure p_{S1i} with the relevant factors f_{Hi}, f_{Gai}, f_{Gbi} and f_{Gi} for an overall process.

By carrying out such a decompression command, it is possible to remove distillate condensed in the condenser at any time during an overall process. The decompression process can be carried out once or several times in an overall process.

In yet another embodiment, the control module of the proposed rotary evaporator is designed to automatically carry out subsequent process steps (I) and (II) and the decompression steps (III), (IV), (V), (VI) and (VII) once and several times in the specified sequence within a step i of n consecutive steps in each case within an overall time interval Δt_{ges} of an overall process:
(I) with the intermediate valve closed, reducing an initial pressure p_{A} or a second limit pressure p_{Gb(i-1)} or an equivalent limit pressure p_{G(i-1)} of the step (i−1) upstream the respective step i to a process pressure pPi within a first time interval Δt₁ᵢ,
(II) with the intermediate valve open, maintaining the process pressure p_{Pi} for a second time interval Δt₂ᵢ,
(III) with the intermediate valve open, reducing the process pressure p_{Pi} to a first limit pressure p_{Gai} or to an equivalent limit pressure p_{Gi} within a third, i.e.: the upstream decompression time interval Δt₃ᵢ,
(IV) with the intermediate valve open, increasing the first limit pressure p_{Gai} or the equivalent limit pressure p_{Gi} to a holding pressure pHi in a fourth, i.e.: the subsequent decompression time interval Δt₄ᵢ,
(V) with the intermediate valve open, maintaining the holding pressure p_{Hi} in a fifth, i.e.: the next decompression time interval Δt₅ᵢ,
(VI) with the intermediate valve open, reducing the holding pressure p_{Hi} to a second limit pressure p_{Gbi} designated or again to the equivalent limit pressure p_{Gi} in a sixth, i.e.: the further decompression time interval Δt₆ᵢ and closing the intermediate valve when the second limit pressure p_{Gbi} or the equivalent limit pressure p_{Gi} is reached,
(VII) process step (I) starting from the second limit pressure p_{Gbi} or the equivalent limit pressure p_{Gi} followed by the process step (II) and the decompression steps (III) to (VII) in the aforementioned sequence for the respective step (i+1) downstream of step i and, after passing through the last step (i=n), reducing the last second limit pressure p_{Gbn} or the last equivalent limit pressure p_{Gn} to a final pressure p_{E} in a final time interval Δt_{E}, i.e.: the final decompression time interval Δt₇ᵢ.

Consequently, in each step i:
a process pressure p_{Pi},
a first limit pressure p_{Gai} assigned to the process pressure p_{Pi} or an equivalent limit pressure p_{Gi},
a holding pressure p_{Hi} associated with the first limit pressure p_{Gai} or with the equivalent limit pressure p_{Gi},
a second step limit pressure p_{Gbi} assigned to the holding pressure p_{Hi} or a limit pressure p_{Gi} equivalent again and
   the final pressure p_{E} is reached after the last step (i=n). The initial pressure pA can be set on the control module:
the initial pressure p_{A} can be set or is given by the atmospheric pressure,
the final pressure p_{E} can be set,
the final time interval Δt_{E} can be set or defined as a switching time,
each first time interval Δt₁ᵢ can be set or defined as a switching time,
each process pressure p_{Pi} and each second time interval Δt₂ᵢ can be set.

Thus:
each process pressure p_{Pi} of a step i is less than the process pressure p_{P(i-1)} of the step (i−1) upstream step i,
each first limit pressure p_{Gai} or equivalent limit pressure p_{Gi} of a step i is less than the first limit pressure p_{Ga(i-1)} or equivalent limit pressure p_{G(i-1)} of the step (i−1), each second limit pressure p_{Gbi} or equivalent limit pressure pGi of a step i is greater than the process pressure p_{P(i+1)} of the step (i+1) downstream of step i.

Here, n corresponds to a natural number from 1 to the number of separable fractions or fractions of a liquid mixture to be separated. The total time interval Δt_{ges} comprises the total time required to carry out a total of n consecutive steps of the overall process. The total time interval Δt_{ges} thus corresponds to the sum of all time intervals Δt₁ᵢ, Δt₂ᵢ, Δt₃ᵢ, Δt₄ᵢ, Δt₅ᵢ, Δt₆ᵢ and Δt_{E} of all steps i, each from i=1 to i=n. The time periods Δt₁ᵢ, Δt₂ᵢ, Δt₃ᵢ, Δt₄ᵢ, Δt₅ᵢ, Δt₆ᵢ and Δt_{E} of all steps i are each independent of one another within a step i and with respect to all steps i.

In a further preferred embodiment, for all n steps i on the control module:
the holding pressures p_{Hi} by entering a common holding pressure factor (hereinafter referred to or abbreviated as: f_{H}),
the first limit pressures p_{Gai} by entering a common first proportional factor (hereinafter referred to or abbreviated as: f_{Ga}) and the second limit pressures p_{Gbi} by entering a common second proportional factor (hereinafter referred to or abbreviated as: f_{Gb}) or the equivalent limit pressures p_{Gi} by entering a common equivalent proportional factor (hereinafter referred to or abbreviated as: f_{G})
   in each case as a product of the individual process pressures p_{Pi} with the relevant factors f_{G}, f_{Ga}, f_{Gb} and f_{H}. To carry out the decompression steps (III) to (VII), the factors f_{Ga}, f_{Gb} and f common to all steps i can each be set to greater than 0 and less than 1 on the control module, whereby the holding pressure factor f_{H} common to all steps i can be set to greater than 1. To carry out the decompression steps, the common proportion factors f_{Ga}, f_{Gb} and f_{G} typically cover a range of less than 1 to 0.8. Typically, the common holding pressure factor fH to carry out the decompression steps covers a range of more than 1 to 1.5.

Thus, by entering a single required set of factors f_{G}, f_{Ga}, f_{Gb} and f_{H}, the effort for the total input of an overall process is minimized. Furthermore, this ensures that the first limit pressures p_{Gai}, second limit pressures p_{Gbi} or the equivalent limit pressures p_{Gi} as well as the holding pressures p_{Hi} each have an equal and therefore appropriate size ratio to one another with regard to each process pressure p_{Pi}.

If the factors f_{H}, f_{Ga}, f_{Gb} and f_{G} equal 1 on the control module, i.e.: f_{H}=f_{Ga}=f_{Gb}=1 or f_{H}=f_{G}=1, the execution of the decompression steps (III) to (VI) is switched off for all steps i.

With the rotary evaporator according to the invention, both single-step (n=1; i={1}) and multi-step (n>1; i={1, . . . n}) overall processes can be carried out. For each process step (I) and (II) of a step i, the relevant first step time interval Δt₁ᵢ, the second step time interval Δt₂ᵢ and the step process pressure p_{Pi} associated with Δt₂ᵢ can be selected individually in such a way that a desired result can be achieved as completely as possible. The process steps (I) and (II) can thus be individually adjusted with the control module to known or predetermined or predefined process conditions for an overall process. Typically, in process steps (I) and (II), the same or different step time intervals Δt₁ᵢ and Δt₂ᵢ comprise 30 s to 6 h, unless one or more first step time intervals Δt₁ᵢ are set as switching time on the control module.

The duration of the end time interval Δt_{E} of the last decompression step (VII) can be set on the control module or defined as a switchover time. If a end time interval Δt_{E} is set on the control module, this typically comprises 1 s to 6 h.

If, in a step i, the second limit pressure p_{Gbi} or the equivalent limit pressure p_{Gi} is equal to the process pressure p_{P(i+1)} of the step (i+1) downstream of step i, the control module is set to recognize the time interval Δt₆ᵢ associated with this step i and the time interval Δt₁₍ᵢ₊₁₎ as a single decompression coinciding completion time interval (hereinafter referred to as: (Δt₃ᵢ=Δt₁₍ᵢ₊₁₎) or abbreviated). In this case, the relevant time segment Δt₆ᵢ corresponds to a switchover time and the associated time segment Δt₁₍ᵢ₊₁₎ corresponds to a formal switchover time of 0 s.

A one-step overall process (n=1), which can be carried out with the rotary evaporator according to the invention, is given, for example, in the drying of a heterogeneous mixture of silica gel with an organic solvent. Another non-limiting example of a one-step overall process is the evaporation of a liquid solution with the proposed rotary evaporator in order to obtain a solid dissolved in the solution.

A multi-step overall process (n>1), which can be carried out with the rotary evaporator according to the invention, is given in particular in the fractional distillation of a liquid mixture. Here, several fractions of distillate can be obtained starting from an initial pressure p_{A} until a final pressure p_{E} set on the control module is reached. Preferably, in each step i for carrying out process steps (I) and (II), the process pressure p_{Pi} is set to the boiling pressure of a fraction p_{Bi} and the second time interval Δt₂ᵢ is selected to be sufficiently long so that the desired fraction can be separated as completely as possible. If there are sufficient differences between the individual boiling pressures p_{Bi}, the time intervals Δt₆ᵢ and Δt₁₍ᵢ₊₁₎ can be selected as switching times.

With the automatic execution of the decompression steps (I) to (VI), which can be accomplished with the rotary evaporator according to the invention, it is particularly advantageous that after their execution in each step i, a flow-off of the residual component of a distillate remaining in the condenser and above all upstream of and at the inlet connection can be accomplished through the open intermediate valve into the relevant receiving flask. In addition, for each fraction which is obtainable in step i, an excessively high negative pressure and a boiling back or rebound of the distillate from the relevant collection flask and thus a partial mixing of the individual fractions can be completely avoided.

In yet another preferred embodiment, the control module of the rotary evaporator according to the invention is designed for optional automatic execution of the decompression steps (VI) and (VII) as a combined final decompression step [(VI)+(VII)] for at least one step i or for all n steps i.

In this case, the sixth time segment Δt₆₍ᵢ₋₁₎ of a step (i−1) upstream the respective step i and the first time segment Δt₁ᵢ of the respective step i in a combined decompression time segment corresponding to a switching time (hereinafter referred to as: (Δt₆₍ᵢ₋₁₎+Δt₁ᵢ) or abbreviated). Alternatively or additionally, for the last step (i=n), the last sixth step time intervall Δt₆ₙ and and the final step time interval Δt_{E} can be set in a combined time interval corresponding to a switching time (hereinafter referred to as: (Δt₆ₙ+Δt_{E}) or abbreviated). This can be carried out for all n steps i, provided that every second limit pressure p_{Gbi} or equivalent limit pressure p_{Gi} is equal to or greater than the process pressure p_{P(i+1)} of the step (i+1) downstream of step i in each case. Combining the decompression steps (VI) and (VII) as a single final step [(VI)+(VII)] makes sense if the boiling pressures p_{Bi} of the fractions concerned differ greatly.

The curves with respect to the current system pressure p_{S} as a function of the time t of the process steps (I) and (II) and decompression steps (III) to (VII), including the decompression command, which can be carried out with the rotary evaporator according to the invention, are continuous overall. Here, the respective progression within a time segment Δt₁ᵢ, Δt₂ᵢ, Δt₃ᵢ, Δt₄ᵢ, Δt₅ᵢ, Δt₆ᵢ, Δt₇ᵢ or Δt_{E}, (Δt₆+Δt₇)i, (Δt₆₍ᵢ₋₁₎+Δt₁ᵢ), (Δt₆ₙ+Δt_{E}) and (Δt₃ᵢ=Δt₁₍ᵢ₊₁₎ is idealized linear or almost linear or concave or convex and/or asymptotic with respect to a subsequent time segment. Within a time interval Δt₁ᵢ, Δt₂ᵢ, Δt₃ᵢ, Δt₄ᵢ, Δt₅ᵢ, Δt₆ᵢ, Δt₇ᵢ or Δt_{E}, (Δt₆+Δt₇)i, (Δt₆₍ᵢ₋₁₎+Δt₁ᵢ), (Δt₆ₙ+Δt_{E}) and (Δt₆ᵢ=Δt₁₍ᵢ₊₁₎), the system pressure p_{S} exhibits a smooth curve as a function of time t. Due to technically induced fluctuations in the control, a superimposed stepwise and/or superimposed periodic curve within a time period can also be generated with the rotary evaporator according to the invention.

The switching times defined or selected on the control module for the mutually independent identical or partially identical or different time Δt₁ᵢ, Δt₂ᵢ, Δt₃ᵢ, Δt₄ᵢ, Δt₅ᵢ, Δt₆ᵢ, Δt₇ᵢ Or Δt_{E}, (Δt₆+Δt₇), (Δₜ₍ᵢ₋₁₎+Δt₁ᵢ), (Δt₆ₙ+Δt_{E}) and (Δt₆ᵢ=Δt₁₍ᵢ₊₁₎ are typically 10-3 s to 5 min depending on the device and/or process.

The system pressure p_{S} S is the controlled variable during the execution of the decompression command, the process steps (I) and (II) as well as the decompression steps (III) to (VII) with the proposed rotary evaporator. The reference variables include the first limit pressures p_{Gai}, the second limit pressures p_{Gbi}, the equivalent limit pressures p_{Gi}, the holding pressures p_{Hi} and the process pressures p_{Pi}. These reference variables are temperature-dependent.

In yet another embodiment, the control module of the rotary evaporator according to the invention is therefore designed to set a temperature (hereinafter referred to or abbreviated as: T_{V}) of the temperature control medium in the temperature control bath to a constant value or to a linear or gradual increase from an initial temperature (hereinafter referred to or abbreviated as: T_{A}) to a final temperature (hereinafter referred to or abbreviated as: T_{E}). Here, the temperature T_{V} corresponds approximately to that of the vaporization flask and thus the liquid or liquid mixture contained therein.

In fractional distillation, the boiling pressures p_{Bi} of the individual fractions can be adjusted to the process pressures p_{Pi} using the control module, whereby the boiling pressures p_{S1i} are temperature-dependent. Preferably, a constant temperature T_{V} can therefore be set with the control module for the duration of each time interval Δt₂ᵢ to a process pressure p_{Pi}. This can be achieved by setting a constant temperature T_{V}, i.e. T_{V}=T_{A}=T_{E}, over the entire time interval Δt_{ges}, which is optimized for all boiling pressures p_{Bi} in the relevant range of the system pressure p_{S} to be set. Alternatively, this can be achieved by optionally setting a temperature ramp over the total time interval Δt_{ges}, whereby a constant boiling temperature (hereinafter referred to as: T_{Bi} or abbreviated) is set for each process pressure p_{Pi} over the respective time interval Δt₂ᵢ and each time interval Δt₇ᵢ is selected to be sufficiently long so that an increase in the boiling temperature T_{Bi} to the higher boiling temperature (hereinafter referred to as: T_{B(i+1)} or abbreviated) of the subsequent step (i+1) is ensured. Alternatively, in the case of sufficiently similar boiling temperatures T_{Bi}, a linear increase in the temperature T_{V} of the temperature control bath from an initial temperature T_{A} to a final temperature T_{E} can also be set over the entire time interval Δt_{ges}.

For example, when carrying out the cracking process from dicyclopentadiene to cyclopentadiene, the temperature T_{V} is constantly set to the decomposition temperature of dicyclopentadiene at 170° C. and the process pressure p_{P1} is set to 950 mbar, so that condensation of cyclopentadiene in the condenser can be achieved. An accumulation of cyclopentadiene in the condenser and at the inlet connection of the intermediate valve can be avoided when carrying out this process with the rotary evaporator according to the invention by triggering the decompression command once or several times.

Thus, by adjusting the temperature T_{V} of the temperature control bath, an overall process can be optimized with regard to a high separation efficiency or obtaining a fraction with a desired composition.

The following describes a particularly preferred embodiment of the rotary evaporator according to the invention with regard to the intermediate valve. The intermediate valve is connected to drain a distillate in each receiving flask. The intermediate valve is connected directly to the condenser via a detachable connection. This allows easy maintenance and cleaning of the intermediate valve.

Preferably, the intermediate valve is designed as an electronically controllable solenoid valve. In this case, the intermediate valve is connected directly to the radiator via a flange connection or screw connection and directly or indirectly to each receiving flask via a detachable connection, preferably via a spherical ground joint. A flange connection and a screw connection have a high level of tightness without the need for greasing. A spherical ground joint allows particularly fast removal or quick replacement of the relevant collection flask, even during the execution of an overall process.

Commercially available reusable valves, which can be used as intermediate valves for the proposed rotary evaporator, usually have no more than three outlets as output connections to the receiving flasks for reasons of design or space.

An indirect connection of the intermediate valve with preferably several receiving flasks can be realized via a spinning template or an autosampler. In this case, an output connection of the intermediate valve is connected to the distribution manifold or the autosampler, whereby the distribution manifold or the autosampler is in turn detachably connected to at least one receiving flask. In typical embodiments, up to ten collectors are connected to the intermediate valve via the distribution manifold or the autosampler. Fractions of a distillate can be distributed into several collection flasks using the spider or the autosampler.

In yet another preferred embodiment of the rotary evaporator according to the invention, each collection flask can be aerated via at least one end aeration valve. In this case, each end aeration valve is designed as an electronically controllable solenoid valve and can be controlled autonomously with the control module. Particularly advantageous, the end aeration valve allows the negative pressure in the relevant collection flask to be equivalent, which means that it can be removed during the entire process and replaced with a new collection flask. The final aeration valve thus provides additional protection against the distillate boiling back out of the collection flask.

The electronic control module of the rotary evaporator according to the invention is designed for setting and automatically controlling the subsequent control steps in the specified sequence as described above:
optional: process step (I) with the subsequent process step (II),
decompression step (III),
decompression step (IV),
decompression step (V),
Decompression step (VI),
decompression step (VIII).

This includes the previously described design of the electronic control module for setting and automatically executing the manually triggerable decompression command.

Preferably, the control module has a display which is designed for setting, for displaying and optionally for graphically representing the previously described control steps and optionally for graphically representing the course of the system pressure p_{S} as a function of the time t with regard to the previously described control steps carried out once or several times. This includes the setting of the manually triggerable decompression command, its display and the optional graphical representation of the course of the system pressure p_{S} as a function of the time t with regard to the decompression command carried out once or several times.

For this purpose, the display has a touchscreen for setting the control steps. The display of the control steps includes the display of the parameters entered on the touchscreen for each control step and for the manually triggered decompression command. The graphical representation of the entered control steps can be shown or called up on the display in the form of a diagram, whereby the diagram shows the course of the system pressure p_{S} as a function of the time t and optionally the diagram has labels with the set parameters.

Furthermore, the display is optionally designed for the graphical representation of the course of the measured system pressure p_{S} as a function of the time t in the form of a diagram relating to the control steps carried out. This diagram can be shown on the display in real time, stored on the control module and subsequently called up on the display. Optionally, the set parameters of the control steps can also be displayed in the diagram.

The problem of the present invention is further solved by a process for the fractional distillation of a liquid or a liquid mixture using the rotary evaporator according to the invention. This process can be carried out automatically with the rotary evaporator according to the invention and comprises the following process steps described above, which can be carried out in the order given:
process step (I),
process step (II),
decompression step (III),
decompression step (IV),
decompression step (V),
decompression step (VI),
readjustment step (VII).

With the rotary evaporator according to the invention, overall processes, in particular fractional distillations, can be carried out in a particularly advantageous automated manner.

With the rotary evaporator according to the invention, an accumulation of distillate in the condenser and at the intermediate valve can be remedied or completely avoided by means of the control module. The proposed rotary evaporator makes it possible to prevent the distillate from boiling back or refluxing from each receiving flask into the condenser.

This makes it particularly advantageous to minimize the size of the condenser and, in particular, the intermediate valve. The minimized sizes of the valve flask and valve seat of the intermediate valve make it possible to achieve particularly advantageous fast switchover times with regard to opening or wearing and thus a fast response of the automated control system.

The rotary evaporator according to the invention prevents mixing of individual fractions by preventing the accumulation of distillate in the condenser during fractional distillation. Thus, with the rotary evaporator according to the invention, optimum purity of the individual fractions can be achieved during fractional distillation.

During an overall process, each receiving flask can be removed from the rotary evaporator according to the invention and replaced.

The rotary evaporator according to the invention is thus characterized by a high level of efficiency during operation.

The control module of the rotary evaporator according to the invention is particularly advantageous for retrofitting existing rotary evaporators at low cost, provided that the system pressure generator and the intermediate valve can be controlled electronically. The control module can also be used for any other distillation device whose control is mainly based on a system pressure p_{S} as a controlled variable.

### DESCRIPTION OF THE EMBODIMENTS

In the following, an embodiment example of the rotary evaporator according to the invention, which does not limit the invention, is explained in more detail with reference to figures. The figures show

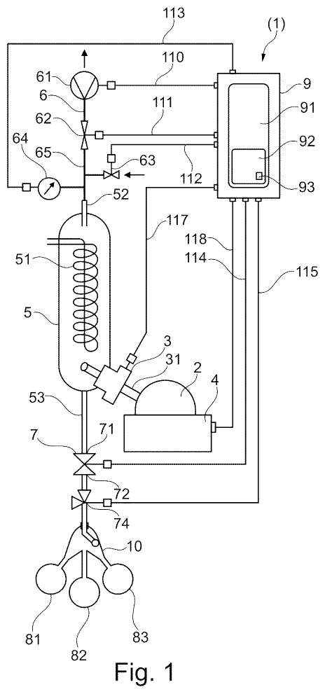

FIG. 1A schematic representation of the rotary evaporator according to the invention with an intermediate valve with an output connection via a distribution manifold to three receiving flasks;

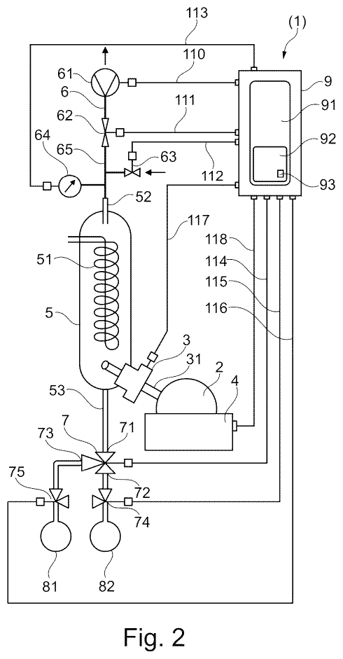

FIG. 2 the same rotary evaporator with an intermediate valve with two output connections to one receiving flask each;

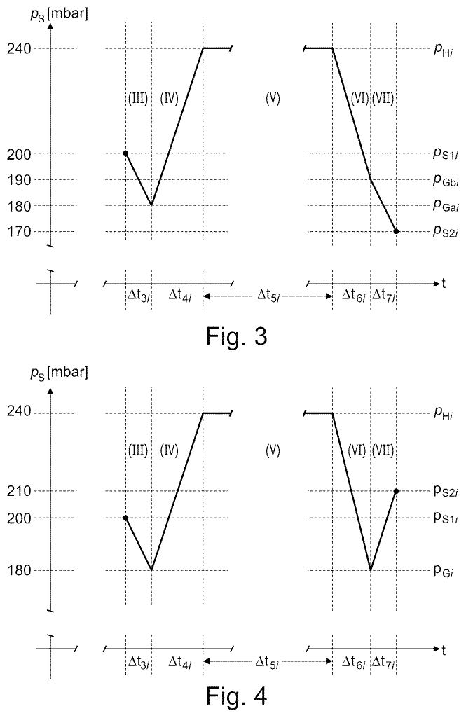

FIG. 3 sections from a schematic system pressure-time diagram showing the execution of the decompression steps (III) to (VII) with the rotary evaporator under control with respect to a first limit pressure p_{Gai} and a second limit pressure p_{Gbi};

FIG. 4 sections of a schematic system pressure-time diagram showing the execution of the decompression steps (III) to (VII) with the rotary evaporator under control with respect to an equivalent limit pressure p_{Gi};

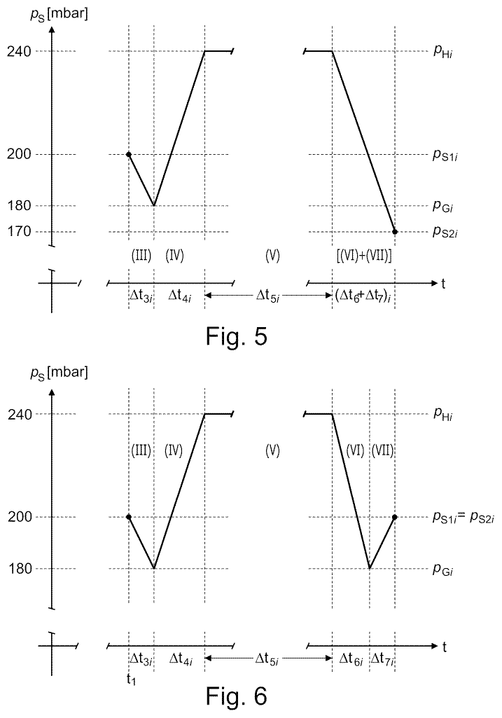

FIG. 5 sections of a schematic system pressure-time diagram showing the execution of the decompression steps (III) to (VII) with the rotary evaporator under control with respect to an equivalent limit pressure p_{Gi} i and with respect to combined steps (VI) and (VII) and thus a combined time interval (Δt₆+Δt₇)i;

FIG. 6 sections of a schematic system pressure-time diagram showing the execution of the decompression command with the rotary evaporator during an overall process;

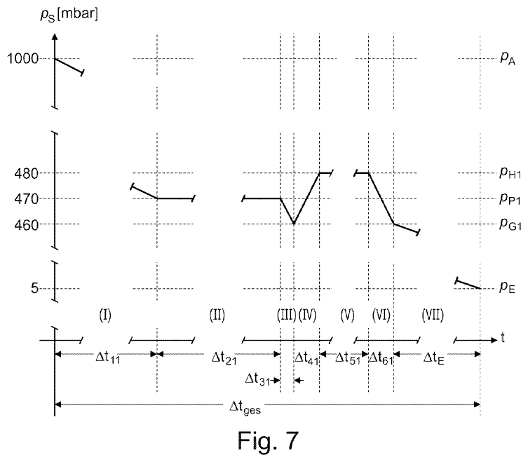

FIG. 7 sections of a schematic system pressure-time diagram for drying a heterogeneous mixture of silica gel and chloroform with the rotary evaporator;

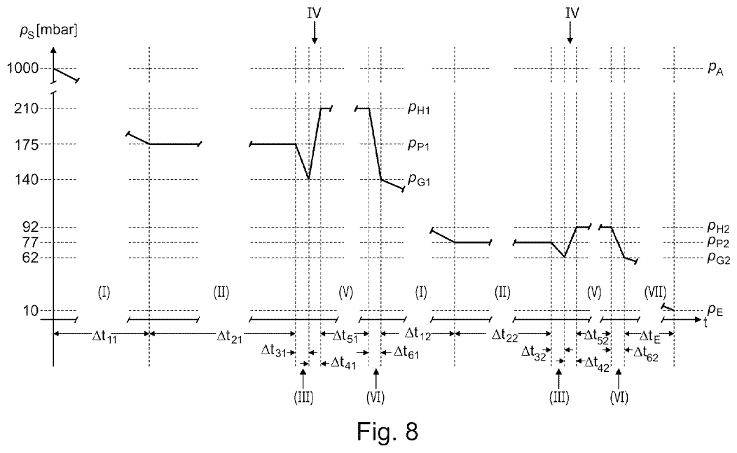

FIG. 8 sections from a schematic system pressure-time diagram of a distillation of a mixture of ethanol and toluene at a constant 40° C., which is carried out with the proposed rotary evaporator.

FIG. 1 and FIG. 2 schematically show the rotary evaporator 1. The rotary evaporator 1 has an evaporation flask 2, an electric motor 3, a temperature control bath 4, a condenser 5, an electric system pressure generator 6, an intermediate valve 7, several receiving flasks (81, 82, 83) and an electronic control module 9. FIG. 1 shows the rotary evaporator 1, which has an intermediate valve 7 with an inlet connection 71 and an outlet connection 72 to a distribution manifold 10, whereby the distribution manifold 10 is connected to three receiving flasks (81, 82, 83). FIG. 2 shows the same rotary evaporator 1, which has an intermediate valve with two output connections (72, 73) to one receiving flask (81, 82) each.

The evaporation flask 2 is designed as a glass flask with a volume of 2 L and is connected to a vapor tube 31 via a detachable ground joint. The vapor tube 31 is guided into the condenser 5 via a shaft seal. The shaft seal and thus the steam pipe 31 and consequently the evaporation flask 2 can be set in rotation by means of the electric motor 3. The steam pipe 31 is made of glass. The ground joint of the steam pipe 31 and the shaft seal are not shown in FIG. 1 and FIG. 2.

The electric temperature control bath 4 is designed to control the temperature of the evaporation flask 2 during operation of the rotary evaporator 1. For this purpose, the evaporation flask 2 is placed in the temperature control bath 4, whereby the temperature control bath 4 is filled with water as the temperature control medium and the water can be heated with an electric heater. The electric heater and the water as a temperature control medium are not shown in FIG. 1 and FIG. 2.

As an assembly, the condenser 5 has an internal cooling coil 51 as a cooling device, the shaft seal, a screw connection 52 to the system pressure generator 6 and a screw connection 53 to the intermediate valve 7. The internal volume of the condenser is 10 liters. The condenser 5 is made of glass except for the shaft seal. The shaft seal of the condenser 5 is not shown in FIG. 1 and FIG. 2.

A temperature-controlled cooling liquid can be circulated through the cooling spiral 51, for example by means of a circulation condenser connected to the cooling spiral 51 via hoses. During operation of the rotary evaporator 1, the cooling liquid is tempered to a lower temperature than the evaporation flask 2. A circulation condenser, connecting hoses and a coolant are not shown in FIG. 1 and FIG. 2.

The system pressure generator 6 has an electric vacuum diaphragm pump 61, an electrically controllable control valve 62, an electrically controllable vent valve 63 and an electronically readable pressure gauge 64. The system pressure p_{S} can be measured with the pressure gauge 64, which is designed as a Pirani probe. The vacuum diaphragm pump 61 is connected to the control valve 62. The control valve 62, the aeration valve 63 and the pressure gauge 64 are connected to the condenser 5 via a common pipe connection 65. The control valve 62 and the ventilation valve 63 are each designed as an electric solenoid valve. The system pressure p_{S} in the condenser 5, the evaporation flask 2 and, optionally via the intermediate valve 7, in the receiving flasks (81, 82, 83) can be adjusted with the control valve 62 and the vent valve 63. The control valve 62, the ventilation valve 63 and the intermediate valve 7 can each be controlled independently of each other. The direction of the arrow drawn on the system pressure generator 6 indicates the direction of flow of the gas conveyed from the evaporation flask 2 through the condenser 5 during operation of the rotary evaporator 1.

As an assembly, the intermediate valve 7 has an inlet connection 71, in FIG. 1 an outlet connection 72 with an end vent valve 74 and in FIG. 2 two outlet connections (72, 73) each with an end vent valve (74, 75). The intermediate valve 7 is designed as an electronically switchable solenoid valve. All end vent valves (74, 75) are also designed as electronically switchable solenoid valves. The end aeration valves (74, 75) are each electronically controllable independently of each other and independently of the intermediate valve 7, the aeration valve 63 and the control valve 62. The intermediate valve 7 is connected to the condenser 5 via the input connection 71, which is designed as a screw connection.

All receiving flasks (81, 82, 83) are each connected via a spherical ground joint either indirectly via the distribution manifold 10 to the output connection 72, as shown in FIG. 1, or directly to the output connections (72, 73) of the intermediate valve 7, as shown in FIG. 2. Each collection flask (81, 82, 83) can be vented via the associated end vent valve (74, 75). Each collection container is designed as a glass flask with an internal volume of 500 mL and is intended for collecting distillate.

In FIG. 1 and FIG. 2, a liquid mixture in the evaporation flask 2 and distillates in the collection flasks (81, 82, 83) are not shown.

The control module 9 has a display 91 as an assembly, whereby a touchscreen 92 is integrated on the display and a button 93 is integrated on the touchscreen 92. The control module 9 is connected via electrical control lines (110, 111, 112, 113, 114, 115, 116, 117, 118) to the vacuum diaphragm pump 61, the control valve 62, the vent valve 63, the pressure gauge 64, the intermediate valve 7 and its end vent valves (74, 75), the electric motor 3 and the temperature control bath 4. Electrical lines for the power supply of all electrically operable components and assemblies of the rotary evaporator are not shown in FIG. 1 and FIG. 2.

The control module 9 is thus designed to electronically control the system pressure generator 6, the intermediate valve 7 and its end vent valves (74, 75), the temperature control bath 4 and the rotational speed of the evaporation flask 2.

The control module 9 of the rotary evaporator 1 is designed to automatically perform the decompression steps (III) to (VII) once or several times by manual triggering by means of a button 93 as a decompression command at any time t1 at a system pressure pS1i of an overall process. The button 93 is located on the touchscreen 92. For this purpose, the touchscreen 92 of the control module is designed for manual input of the following parameters:
first proportional factor f_{Gai} for a first limit pressure p_{Gai} and second proportional factor f_{Gbi} for a second limit pressure p_{Gbi} or alternatively equally selected proportional factor f_{Gi} for an equivalent limit pressure p_{Gi},
holding pressure factor f_{Hi} for a holding pressure p_{Hi}.

Thus, the first limit pressure p_{Gai} can be determined by entering the first proportional factor f_{Gai} and the second limit pressure p_{Gbi} by entering the second proportional factor f_{Gbi} or, alternatively, the equivalent limit pressure p_{Gi} by entering the equivalent proportional factor f_{Gi} and the holding pressure p_{Hi} by entering the holding pressure factor f_{Hi}, each as a product of the selected first system pressure p_{S1i} with the respective factors f_{Gai}, f_{Gbi}, f_{Gi} and f_{Hi}.

By holding the switched button 93, a time interval Δt₅ᵢ can be individually selected for the decompression step (V) after running through the decompression steps (III) and (IV) during execution of the decompression command. After releasing the switched button 93, the control module 9 is designed for the subsequent automatic execution of the decompression steps (VI) and (VII) and thus for the continuation of the overall process, whereby the time intervals Δt₃ᵢ for the decompression step (III), Δt₄ᵢ for the decompression step (IV), Δt₆ᵢ for the decompression step (VI) and Δt₇ᵢ for the decompression step (VII) are defined as switchover times on the control module 9 for the execution of the decompression command.

Furthermore, the control module 9 of the rotary evaporator 1 is for setting and automatically carrying out subsequent control steps of an overall process once or several times:
process step (I),
process step (II),
decompression step (III),
decompression step (IV),
decompression step (V),
decompression step (VI) and
decompression step (VII)
   are programmed and trained in the specified sequence. The setting of these control steps comprises the manual input of the following parameters for all n steps i on the touch screen 92:
Initial pressure p_{A},
Final pressure p_{E} of the last step (i=n),
End time interval Δt_{E} as a value or switching time,
first time segment Δt₁ᵢ as value or switchover time,
Process pressures p_{Pi} with the assigned second time intervals Δt₂ᵢ,
common holding pressure factor f_{H},
common first proportional factor f_{Ga} and common second proportional factor f_{Gb} for all steps i or alternatively common equally selected proportional factor fa for all steps i, individually adjustable fifth step time intervals for each step i Δt₅ᵢ.

Thus, the holding pressures p_{Hi} can be determined by entering a common holding pressure factor f_{H}, the first limit pressures p_{Gai} by entering the common first proportional factor f_{Ga} and the second limit pressures p_{Gbi} by entering the common second proportional factor f_{Gb} or, alternatively, the equivalent limit pressures p_{Gi} by entering the common equivalent proportional factor f_{G}, each as a product of the individual process pressures p_{Pi} with the respective factors f_{H}, f_{Ga}, f_{Gb} and f_{G}.

In addition, the control module 9 of the rotary evaporator 1 is designed for optional setting and automatic execution of the decompression steps (VI) and (VII) as a combined final decompression step [(VI)+(VII)] for at least one step i or for all n steps i. The setting of these end steps [(VI)+(VII)] additionally comprises the manual definition of subsequent parameters as switchover times on the touchscreen 92 for the steps i concerned:
summarized decompression step time intervals (Δt₆₍ᵢ₋₁₎+Δt₁ᵢ),
summarized end step time interval (Δt₆ₙ+Δt_{E}).

On the touchscreen 92 and thus on the control module 9, the temperature T_{V} of the temperature control bath 4 can also be set manually to a constant value or to a linear or gradual increase from an initial temperature T_{A} to a final temperature T_{E}.

The graphical representation of the entered control steps can be shown or called up in the form of a diagram on the display 91, whereby the diagram shows the course of the system pressure p_{S} and the temperature T_{V} of the temperature control bath 4 as a function of the time t and the diagram has labels with the set parameters and their values. The diagram is scaled with regard to the values of the temperature T_{V}, the system pressure p_{S} and the time. This diagram can be shown on the display in real time, stored on the control module 9 and subsequently called up on the display 91. In addition, the set parameters and their values can be displayed in the diagram. This diagram is also scaled with regard to the values of the temperature T_{V}, the system pressure p_{S} and the time.

The rotation speed of the evaporation flask 2 can also be controlled on the touchscreen 92. The set and current rotation speed can be called up and displayed on the display 92. In the diagram relating to the control steps carried out and the temperature curve, the rotational speed can be called up and displayed on the display 91 as a function of the time t using the touchscreen 92.

In the following sections, the respective relevant sections from the schematic system pressure-time diagrams of FIG. 3, FIG. 4, FIG. 5, FIG. 6, FIG. 7 and FIG. 8 are described in more detail. For better illustration, relevant sections are shown enlarged by interrupting the axis. FIG. 3, FIG. 4, FIG. 5, FIG. 6, FIG. 7 and FIG. 8 show the relevant decompression steps (III), (IV), (V), (VI), (VI) and [(VI)+(VII)], the corresponding time intervals Δt₁ᵢ, Δt₂ᵢ, Δt₃ᵢ, Δt₄ᵢ, Δt₅ᵢ, Δt₆ᵢ, Δt₇ᵢ, Δt_{E} and (Δt₆+Δt₇)i. The time periods Δt₁ᵢ, Δt₂ᵢ, Δt₃ᵢ, Δt₄ᵢ, Δt₅ᵢ, Δt₆ᵢ, Δt₇ᵢ, Δt_{E} and (Δt₆+Δt₇)i correspond to switching times in a range from 10⁻³ s to 1 s. Where relevant, the initial pressure p_{A}, final pressure p_{E} and the reference variables pₛ₁ᵢ, p_{S2i}, p_{Gai}, p_{Gbi}, p_{Gi}, p_{Hi} and p_{Pi} are shown in FIG. 3, FIG. 4, FIG. 5, FIG. 6, FIG. 7 and FIG. 8.

In FIG. 3, FIG. 4, FIG. 5 and FIG. 6, the first system pressure p_{S1i} is 200 mbar and the holding pressure pHi is 240 mbar for a common holding pressure factor f_{H} of 1.2 set on the touchscreen for FIG. 3, FIG. 4 and FIG. 5 and for a holding pressure factor f_{Hi} of 1.2 set on the touch screen for FIG. 6. In FIG. 3, the first limit pressure p_{Gai} is 180 mbar for a first common fraction factor f_{Ga} of 0.9 set on the touch screen 92. In FIG. 4, FIG. 5 and FIG. 6, the equivalent limit pressure p_{Gi} is also 180 mbar for a common equivalent proportional factor f_{G} of 0.9 set on the touch screen for FIG. 3, FIG. 4 and FIG. 5 and for an equivalent proportional factor f_{Gi} of 0.9 set on the touch screen. FIG. 3, FIG. 4, FIG. 5 and FIG. 6 are therefore comparable with each other and are each to be understood as an excerpt from an overall process, in which the decompression steps (III), (IV), (V), (VI) and [(VI)+(VII)] are illustrated. In each case, the holding pressure p_{Hi} is higher than the first system pressure p_{S1i}, higher than the first limit pressure p_{Gai} in FIG. 3 and the second limit pressure p_{Gbi} in FIG. 3 or than the equivalent limit pressure p_{Gi} in FIG. 4, FIG. 5 and FIG. 6 and higher than the second system pressure p_{S2i}. In FIG. 3, FIG. 4, FIG. 5 and FIG. 6, the decompression steps (III) to (V) are carried out with the intermediate valve 7 automatically open, during which the distillate remaining at the inlet connection of the intermediate valve 7 and in the condenser 5 is completely drained into the receiving flask 82. In FIG. 3, FIG. 4 and FIG. 5, the time interval Δt₅ᵢ of 1 min set on the touchscreen 92 is sufficiently long for this purpose.

FIG. 3 shows sections of a schematic system pressure-time diagram, which include the automatic execution of the decompression steps (III) to (VII) with the rotary evaporator 1 under control with respect to a first limit pressure p_{Gai} and a second limit pressure p_{Gbi} of 190 mbar. A second proportional factor f_{Gbi} of 0.95 is thus entered on the touch screen 92 for the second limit pressure p_{Gbi}. Here, the first system pressure p_{S1i} is greater than the second system pressure p_{S2i} of 170 mbar and the first limit pressure p_{Gai} is less than the second limit pressure p_{Gbi}. In the decompression step (VI), the intermediate valve 7 is automatically closed when the second limit pressure p_{Gbi} is reached. In the entire decompression step (VII) when the second system pressure p_{S2i} is reached, the intermediate valve 7 is closed.

FIG. 4 shows sections of a schematic system pressure-time diagram showing the automatic execution of the decompression steps (III) to (VII) with the rotary evaporator 1 under control with respect to an equivalent limit pressure p_{Gi}. Here, the first system pressure p_{S1i} is lower than the second system pressure p_{S2i} of 210 mbar. In the decompression step (VI), the intermediate valve 7 is automatically closed when the equivalent limit pressure p_{Gi} is reached. In the entire decompression step (VII) when the second system pressure p_{S2i} is reached, the intermediate valve 7 is closed.

FIG. 5 shows sections from a schematic system pressure-time diagram, which show the automatic execution of the decompression steps (III) to (VII) with the rotary evaporator 1 under control with respect to an equivalent limit pressure pGi and with respect to combined steps (VI) and (VII) and thus a combined time interval (Δt₆+Δt₇)i. For this purpose, the time intervals Δt₃ᵢ and Δt₇ᵢ were set on the touchscreen 92 as a combined decompression time interval (Δt₆+Δt₇)i corresponding to a switching time in the form of a combined final decompression end step [(VI)+(VII)]. In the combined time interval (Δt₆+Δt₇)i, the holding pressure p_{Hi}, the equivalent limit pressure p_{Gi} and the second system pressure p_{S2i} of 170 mbar lie on a line in the system pressure-time diagram. This shows that the decompression steps (VI) and (VII) can be combined if the second system pressure p_{S2i} is equal to or less than the equivalent limit pressure p_{Gi} as shown in FIG. 5. In the decompression end step [(VI)+(VII)], the intermediate valve 7 is automatically open until the equivalent limit pressure p_{Gi} is reached; when the equivalent limit pressure p_{Gi} is reached, the intermediate valve 7 is automatically closed.

FIG. 6 shows sections of a schematic system pressure-time diagram showing the automatic execution of the decompression command with the rotary evaporator 1 during an overall process. The decompression command can be triggered or initiated manually with the button 93. Here, the first system pressure p_{S1i} is equal to the second system pressure p_{S2i} of 200 mbar and thus the second system pressure p_{S2i} is greater than the equivalent limit pressure p_{Gi}. Manual actuation of button 93 triggers the decompression steps (III) and (IV). By holding the switched button 93, a sufficiently long time interval Δt₅ᵢ of 1 min is selected in FIG. 6 for the decompression step (V) until the distillate remaining at the inlet connection of the intermediate valve 7 and in the condenser 5 has completely flowed into the receiving flask 82. After releasing the switched button 93, the subsequent automatic execution of the decompression steps (VI) and (VII) is triggered by the control module 9. In decompression step (VI), the intermediate valve 7 is closed when the equivalent limit pressure p_{Gi} is reached. In the entire decompression step (VII), when the second system pressure p_{S2i} is reached, the intermediate valve 7 is automatically closed. After the decompression step (VII) has been carried out, the entire process is automatically continued by the rotary evaporator 1.

FIG. 7 shows sections of a schematic system pressure-time diagram for drying a heterogeneous mixture of silica gel and chloroform with the rotary evaporator 1 at a constant temperature T_{V} of 40° over the entire time interval Δt_{ges} of this overall process. For illustration purposes, the total time interval Δt_{ges} is shown in FIG. 7. This is a one-step process (n=1), whereby the single step (i=1) comprises the control steps (I) to (VII).

In order to prevent the mixture from shooting through the rotary evaporator 1, the first time interval Δt₁₁ in FIG. 7 is selected as a continuous pressure reduction or pressure ramp starting from an initial pressure p_{A} of 1000 mbar to the process pressure p_{Pi} of 45 min, which is sufficiently long to ensure complete outgassing of the mixture. In process step (I), the intermediate valve 7 is closed in order to ensure easier recovery of the mixture from the rotary evaporator 1 in the event of the mixture shooting through, to protect the intermediate valve 7 itself from contamination and to make it easier to clean the rotary evaporator 1.

In FIG. 7, in process step (II), the process pressure p_{P1} is set to the boiling pressure of chloroform at 470 mbar at 40° C., whereby the second time interval Δt₂₁ of 90 min is selected on the touchscreen 92 to be sufficiently long to ensure that the chloroform evaporates as completely as possible. Here, the intermediate valve 7 is open in order to collect the chloroform in a receiving flask 82.

In FIG. 7, a common holding pressure factor f_{H} of 1.021 for a holding pressure p_{H1} of 480 mbar and a common equally selected proportion factor f_{G} of 0.979 for an equivalent limit pressure p_{G1} of 460 mbar are set on the touch screen 92 for the decompression steps (III) to (VI). The decompression steps (III) to (V) are carried out with the intermediate valve 7 open, during which the distillate remaining at the inlet connection 71 of the intermediate valve 7 and in the condenser 5 is completely drained off. The fifth time interval Δt₅₁ of 2 minutes set on the touchscreen 92 is sufficiently long for this purpose. In the decompression step (VI), the intermediate valve 7 is closed when the equivalent limit pressure p_{G1} is reached.

Only after the residual portions of the condensed chloroform have been removed from the condenser 5 by means of the preset and automatically performed decompression steps (III) to (VI) can the silica gel remaining in the evaporation flask 2 be drawn dry in decompression step (VII). Since the receiving flask 82 is closed by the intermediate valve 7, the chloroform cannot boil back into the condenser 5 and excessive negative pressure in the receiving flask 81 itself is avoided. The collection flask 81 can be vented with the end vent valve 73. This also prevents an excessively high gas load of chloroform in the system pressure generator 6.

For the decompression step (VII) shown in FIG. 7, a final time interval Δt_{E} of 120 min and a final pressure p_{E} of 5 mbar are set on the touchscreen 92. The final time interval Δt_{E} is selected to be sufficiently long so that with a continuous pressure reduction from the limit pressure p_{Gi} to the final pressure P_{E}, complete removal of chloroform from the silica gel can be realized without eruptive shooting of the silica gel into the condenser 5. In the decompression step (VII), the intermediate valve 7 is closed in order to ensure easier recovery of the silica gel from the rotary evaporator 1 if it shoots through, to protect the intermediate valve 7 itself from contamination and to make it easier to clean the rotary evaporator 1.

FIG. 8 shows sections of a schematic system pressure-time diagram of a distillation of a mixture of ethanol and toluene at a constant temperature T_{V} of 40° over the entire time interval Δt_{ges} of this overall process, which is carried out automatically with the proposed rotary evaporator 1. In FIG. 8, the total time interval Δt_{ges} of this overall process is not shown. This is a two-step process (n=2). The first step (i=1) comprises the control steps (I) to (VI), whereby the decompression step (VII) that actually follows the decompression step (VI) corresponds to the process step (I) of the second step (i=2). The second step (i=2) thus comprises the control steps (I) to (VII). The intermediate valve 7 is automatically closed when process step (I) is carried out in the first (i=1) and in the second step (i=2) and is automatically open when process step (II) is carried out in the first (i=1) and in the second step (i=2), automatically opened when performing the decompression steps (III) to (V) in the first (i=1) and in the second step (i=2) and opened at the beginning when performing the decompression steps (VI) in the first (i=1) and in the second step (i=2) and closed when the respective equivalent limit pressures p_{G1} and p_{G2} are reached. When the decompression step (VII) is carried out in the second step (i=2), the intermediate valve 7 is closed.

For the distillation in FIG. 8, a common holding pressure factor f_{H} of 1.2 for a holding pressure pH1 in the first step (i=1) and for a holding pressure pH2 in the second step (i=2) as well as a common equally selected proportion factor f_{G} of 0.8 for an equivalent limit pressure p_{Gi} in the first step (i=1) and for an equivalent limit pressure p_{G2} in the second step (i=2) are set on the touch screen 92 for the decompression steps (III) to (VI). Thus, the holding pressure pH1 and the equivalent limit pressure p_{G1} in the first step (i=1) as well as the holding pressure pH2 and the equivalent limit pressure p_{G2} in the second step (i=2) each have an equal size ratio of 1.5 to each other. With the decompression steps (III) to (VI), a complete removal of residual portions of condensed ethanol is realized in the first step (i=1) and a complete removal of residual portions of condensed toluene is realized in the second step (i=2) at the inlet connection 71 of the intermediate valve 7 and in the condenser 5.

In FIG. 8, a first time interval Δt₁₁ of 20 min is selected for the process step (I) of the first step (i=1) of the distillation, starting from a set initial pressure p_{A} of 1000 mbar on the touch screen 92, in order to achieve heating of the liquid mixture in the evaporation flask 2 to 40° C. A process pressure p_{P1} of 175 mbar is set on the touchscreen 92 for the first step (i=1), which corresponds to the boiling pressure of ethanol at 40° C. For the process step (II) of the first step (i=1), a second time interval Δt₂₁ of 40 min is set to ensure complete distillation of ethanol into the first receiving flask 81. The final aeration valve 74 can be used to aerate the collection flask 81. For the decompression steps (III) to (VI) in the first step (i=1), the limit pressure p_{Gi} is automatically set to 140 mbar by the control module 9 by means of the common equally selected proportion factor fa and the holding pressure p_{Hi} is automatically set to 210 mbar by means of the common holding pressure factor f_{H}.

For the process step (I) of the second step (i=2) of the distillation in FIG. 8, a first time interval Δt₁₂ of 15 min is selected starting from the limit pressure p_{G1} of the first step (i=1) in order to realize the most complete possible removal of ethanol from the gas phase in the evaporation flask 2 and in the condenser 5. A process pressure p_{P2} of 77 mbar is set on the touchscreen 92 for the second step (i=2) of the distillation, which corresponds to the boiling pressure of toluene at 40° C. For the process step (II) of the second step (i=2), a second time interval Δt₂₂ of 60 min is set to ensure complete distillation of toluene into the second receiving flask 82. The collection flask 82 can be vented with the final vent valve 75. For the decompression steps (II) to (VI) in the second step (i=2), the limit pressure pG2 is automatically set to 62 mbar by the control module 9 by means of the common equally selected proportion factor fG and the holding pressure p_{H2} is automatically set to 92 mbar by means of the common holding pressure factor f_{H}.

The decompression step (VII) of the second step (i=2) in FIG. 8 comprises the reduction of the limit pressure p_{G2} to the final pressure p_{E} of 10 mbar set on the touchscreen 92. For this purpose, an end time interval Δt_{E} of 5 min is set on the touchscreen 92.

By closing the intermediate valve 7 after the process steps (II) and the decompression steps (III) to (VII) have been carried out, ethanol is prevented from boiling back out of the collection flask 81 and toluene from the collection flask 82 into the condenser 5 and a high vacuum is prevented in the collection flasks (81, 82).

### LIST OF REFERENCE SYMBOLS

1 Rotary evaporator
2 Evaporation flask
3 Electric motor
31 Steam pipe
4 Tempering bath
5 Condenser
51 Cooling coil
52 Screw connection
53 Screw connection
6 System pressure generator
61 Vacuum diaphragm pump
62 Control valve
63 Vent valve
64 Pressure gauge
65 Pipe connection
7 Intermediate valve
71 Inlet connection
72 Outlet connection
73 Outlet connection
74 End vent valve
75 End vent valve
81 Receiving flask
82 Receiving flask
83 Collector flask
9 Electronic control module
91 Display
92 Touch screen
93 Button
10 Distribution manifold
110 Electrical control line from control module 9 to vacuum diaphragm pump 61
111 Electrical control line from control module 9 to control valve 62
112 Electrical control line from control module 9 to the ventilation valve 63
113 Electrical control line from control module 9 to pressure gauge 64
114 Electrical control line from control module 9 to intermediate valve 7
115 Electrical control line from control module 9 to final aeration valve 74
116 Electrical control line from control module 9 to end vent valve 75
117 Electrical control line from control module 9 to electric motor 3
118 Electrical control line from the control module 9 to the temperature control bath 4

1. Rotary evaporator (1), having a system pressure generator (6), an intermediate valve (7) connected directly or indirectly between a condenser (5) and each receiving flask (81, 82, 83), a control module (9) designed for electronically controlling the system pressure generator (6) and the intermediate valve (7) and, optionally, a temperature control bath (4), characterized in that in that the control module (9) is designed and programmed for the automatic execution of subsequent decompression steps (III) to (VII) in the specified sequence within a step i or as a separate step i of in each case n consecutive steps of an overall process:
(III) the intermediate valve (7) open, reduction of a first system pressure p_{S1i} to a first limit pressure p_{Gai} within an upstream decompression time interval Δt₃ᵢ,
(IV) with the intermediate valve (7) open, increasing the limit pressure p_{Gai} to a holding pressure p_{Hi} in a subsequent decompression time interval Δt₄ᵢ,
(V) with the intermediate valve (7) open, maintaining the holding pressure p_{Hi} for a next decompression time interval Δt₅ᵢ,
(VI) with the intermediate valve (7) open, reducing the holding pressure p_{Hi} to a second limit pressure p_{Gbi} in a further decompression time interval Δt₆ᵢ and closing the intermediate valve (7) when the second limit pressure p_{Gbi} is reached,
(VII) with the intermediate valve (7) closed, regulating the second limit pressure p_{Gbi} to a second system pressure p_{S2i} within a final decompression time interval Δt₇ᵢ,
where i is a natural number from 1 to n and n also corresponds to a natural number from 1 to the number of steps i which can be carried out with the rotary evaporator with respect to identical, partially identical or different operations within an overall process, the control module (9) being used to control the first system pressure p_{S1i}, the second system pressure p_{S2i}, the first limit pressure p_{Gai}, the holding pressure p_{Hi}, the second limit pressure p_{Gbi}, and the time interval Δt₅ᵢ can be set or the first limit pressure p_{Gai}, the holding pressure p_{Hi} and the second limit pressure p_{Gbi} can be set automatically in relation to the first system pressure p_{S1i}, the time intervals Δt₃ᵢ, Δt₄ᵢ, and Δt₆ are each defined as switching times on the control module (9), the Zeitabschnitt Δt₇ᵢ can be set with the control module (9) or can be defined as a switching time or, alternatively, for a second system pressure p_{S2i} equal to or less than the second limit pressure p_{Gbi}, the time intervals Δt₆ᵢ and Δt₇ᵢ are defined or can be set on the control module (9) as a combined decompression time interval (Δt₆+Δt₇)i corresponding to a switching time in the form of a combined final decompression end step [(VI)+(VII)].

2. Rotary evaporator (1) according to claim 1, characterized in that the first limit pressure p_{Gai} of step i is equal to the second limit pressure p_{Gbi} of the same step i and thus corresponds to an equivalent limit pressure p_{Gi} of step i (p_{Gai}=p_{Gbi}=p_{Gi}).

3. Rotary evaporator (1) according to claim 1, characterized in that the control module (9) is designed and programmed to automatically carry out the decompression steps (III) to (VII) by manually triggering an decompression command at any time t₁ with a first system pressure p_{S1i} of an overall process, and the first system pressure p_{S1i} is set equal to the second system pressure p_{S2i}, wherein a time interval Δt₅ᵢ can be preset on the control module (9) or can be selected by a switching duration of an actuated switching device (93) during execution of the decompression command, and wherein the time intervals Δt₆ᵢ and Δt₇ᵢ are each independent of one another and are each defined on the control module (9) as a switching time.

4. Rotary evaporator (1) according to claim 1, characterized in that the control module (9) is designed and programmed for the single and multiple automatic execution of subsequent process steps (I) and (II) as well as the decompression steps (III), (IV), (V), (VI) and (VII) in the specified sequence within a step i of n consecutive steps in each case within an overall process:
(I) with the intermediate valve (7) closed, reducing an initial pressure p_{A} or a second limit pressure p_{Gb(i-1)} or an equivalent limit pressure p_{G(i-1)} of the step (i−1) upstream the respective step i to a process pressure p_{Pi} within a first time interval Δt₁ᵢ,
(II) with the intermediate valve (7) open, maintaining the process pressure p_{Pi} for a second time interval Δt₂ᵢ,
(III) with the intermediate valve (7) open, reducing the process pressure p_{Pi} to a first limit pressure p_{Gai} or to an equivalent limit pressure p_{Gi} within a third time interval Δt₃ᵢ,
(IV) with the intermediate valve (7) open, increasing the first limit pressure p_{Gai} or the equivalent limit pressure p_{Gi} to a holding pressure p_{Hi} in a fourth time interval Δt₄ᵢ,
(V) with the intermediate valve (7) open, maintaining the holding pressure p_{Hi} in a fifth time interval Δt₅ᵢ,
(VI) with the intermediate valve (7) open, reducing the holding pressure p_{Hi} to a second limit pressure p_{Gbi} or again to the equivalent limit pressure p_{Gi} in a sixth time interval Δt₆ᵢ and closing the intermediate valve (7) when the second limit pressure p_{Gbi} or the equivalent limit pressure p_{Gi} is reached,
(VII) process step (I) starting from the second limit pressure p_{Gbi} or the equivalent limit pressure p_{Gi} followed by the process step (II) and the decompression steps (III) to (VII) in said sequence for the respective step (i+1) downstream of step i and, after passing through the last step (i=n), reducing the last second limit pressure G_{bn} or the last equivalent limit pressure p_{Gn} to a final pressure p_{E} in a final time interval Δt_{E},
where n corresponds to a natural number from 1 to the number of separable fractions of a liquid mixture, the initial pressure p_{A} being adjustable or given by the atmospheric pressure on the control module (9) in each case, the final pressure p_{E} being adjustable, the final time interval Δt_{E} being adjustable or determinable as a switching time, each time interval t₁ᵢ being adjustable or determinable or fixed as a switching time, and each process pressure p_{Pi} and each time interval Δt₂ᵢ being adjustable.

5. Rotary evaporator (1) according to claim 4, characterized in that the control module (9) for selective automatic execution of the decompression steps (VI) and (VII) is designed as a combined final decompression end step [(VI)+(VII)] for at least one step i or for all n steps i.

6. Rotary evaporator (1) according to claim 1, characterized in that the control module (9) is designed to set the temperature T_{V} of the tempering bath (4) to a constant value or to a linear or gradually increasing course from an initial temperature T_{A} to a final temperature T_{E}.

7. Rotary evaporator (1) according to claim 1, characterized in that the intermediate valve (7) is designed as an electronically controllable solenoid valve, is connected to the condenser (5) via a flange connection or screw connection and either directly or via a distributor device (10) in each case via a detachable connection to each receiving flask (81, 82, 83).

8. Rotary evaporator (1) according to claim 1, characterized in that each receiving flask (81, 82, 83) can be vented via at least one end vent valve (74, 75), wherein each end vent valve (74, 75) is designed as an electronically controllable solenoid valve and wherein each end vent valve (74, 75) can be controlled autonomously with the control module.

9. Electronic control module (9) for the rotary evaporator (1) according to claim 1, designed for setting and automatically controlling subsequent control steps in the specified sequence:
optionally: process step (I) with the subsequent process step (II),
decompression step (III),
decompression step (IV),
decompression step (V),
decompression step (VI),
decompression step (VII).

10. Electronic control module (9) according to claim 9, characterized by a display (91) which is designed for setting, for displaying and optionally for graphically representing the control steps and optionally for graphically representing the course of the system pressure p_{S} as a function of the time t with respect to the control steps carried out, the display (91) having a touch screen (92) for setting the control steps.

11. Method of fractional distillation of a liquid or a liquid mixture, which can be carried out automatically with the rotary evaporator (1) according to claim 1, characterized by the following process steps, which can be carried out in the specified sequence:
process step (I),
process step (II),
decompression step (III),
decompression step (IV),
decompression step (V),
decompression step (VI),
readjustment step (VII).
